(19) United States
(12) Patent Application Publication
(10) Pub. No.: US 2015/0149325 A1
(43) Pub. Date: May 28, 2015

(54) PURCHASE MANAGEMENT DEVICE, PURCHASE MANAGEMENT METHOD, PROGRAM, AND COMPUTER READABLE MEMORY MEDIUM

(71) Applicant: Rakuten, Inc., Tokyo (JP)

(72) Inventor: Hisanori Yamahara, Shinagawa-ku (JP)

(73) Assignee: Rakuten, Inc., Tokyo (JP)

(21) Appl. No.: 14/404,476

(22) PCT Filed: Apr. 23, 2013
(86) PCT No.: PCT/JP2013/061884

§ 371 Date: Nov. 28, 2014

(30) Foreign Application Priority Data
May 31, 2012 (JP) 2012-125480

(51) Int. Cl. G06Q 30/06; G06Q 20/12

(52) U.S. Cl. CPC G06Q 30/0635; G06Q 20/12
USPC 705/26.81

(57) ABSTRACT

Provided is a technology for more flexibly managing a maximum amount of payment in e-commerce. A purchase managing server causes a storage unit to store a maximum amount of payment, which is input by a user, in a predetermined period, executes purchase processing according to a current purchase including one or more items that the user purchases, each of the one or more items being at least one of goods and service, and determines whether or not to limit current purchase processing based on at least either one of the current purchase and a past purchase of the user, in a case where a total of a payment amount of the user in the predetermined period and a payment amount of the current purchase exceeds the maximum amount of payment.

### TECHNICAL FIELD

The present invention relates to a purchase managing device, a purchase managing method, a program, and a computer-readable storage medium.

### BACKGROUND ART

There is a method for setting a maximum amount of payment of a user during a predetermined period of time (e.g., a month) at a web site selling merchandise. The user may set the maximum amount of payment to any amount.

Patent Literature 1 describes an e-commerce system in which a user sets a maximum amount of transaction as mentioned above, and when a sum of a total transaction amount in a predetermined period and a total amount of current order exceeds the maximum amount of transaction, order processing is stopped.

### CITATION LIST

### Patent Literature

Patent Literature 1: JP2002-109437A

### SUMMARY OF INVENTION

### Technical Problem

One of the purposes to set a maximum amount of transaction as described above is to reduce waste of money. However, when mainly considering the purpose of reducing waste of money, sometimes it may not appropriate not to permit a case in which a sum of a total amount of past payment and a total amount of current order exceeds the maximum amount of payment.

One or more embodiments of the present invention have been conceived in view of the above, and an object thereof is to provide a technique for more flexibly managing expenditures of a user with use of the maximum amount of payment.

### Solution to Problem

In order to solve the above described problems, a purchase managing device according to the present invention includes maximum payment inputting means for causing a storage unit to store a maximum amount of payment in a predetermined period, the maximum amount of payment being input by a user, purchase means for executing purchase processing according to a current purchase including one or more items that the user purchases, the one or more items being at least one of goods or services, and limiting means for determining whether or not to limit current purchase processing by the purchase means based on at least either one of current purchase and past purchase of the user, in a case where a total of a payment amount of the user in the predetermined period and a payment amount of the current purchase exceeds the maximum amount of payment.

Further, a purchase managing method according to the present invention includes the steps of causing a storage unit to store a maximum amount of payment in a predetermined period, the maximum amount of payment being input by a user, executing purchase processing according to a current purchase including one or more items that the user purchases, the one or more items being at least one of goods or services, and determining whether or not to limit current purchase processing based on at least either one of current purchase and past purchase of the user, in a case where a total of a payment amount of the user in the predetermined period and a payment amount of the current purchase exceeds the maximum amount of payment.

Further, a program according to the present invention causes a computer to execute causing a storage unit to store a maximum amount of payment in a predetermined period, the maximum amount of payment being input by a user, executing purchase processing according to a current purchase including one or more items that the user purchases, the one or more items being at least one of goods or services, and determining whether or not to limit current purchase processing based on at least either one of current purchase and past purchase of the user, in a case where a total of a payment amount of the user in the predetermined period and a payment amount of the current purchase exceeds the maximum amount of payment.

Further, a computer-readable information storage medium according to the present invention stores the program.

According to the present invention, expenditures of a user can be more flexibly managed using the maximum amount of payment.

In one embodiment of the present invention, the limiting means may determine whether or not to limit the current purchase processing based on an attribute of the one or more items that the user currently purchases, in a case where the total of the payment amount of the user in the predetermined period and the payment amount of the current purchase exceeds the maximum amount of payment.

In one embodiment of the present invention, the limiting means may determine whether or not to limit the current purchase processing based on information for associating an attribute of an item with whether or not the item is a purchase limit target and the attribute of the one or more items that the user wishes to purchase, in a case where the total of the payment amount of the user in the predetermined period and the payment amount of the current purchase exceeds the maximum amount of payment.

In one embodiment of the present invention, the limiting means may determine whether or not to limit the current purchase processing based on a price of the one or more items that the user purchases, the price being obtained from means for storing respective prices of a plurality of items, in a case where the total of the payment amount of the user in the predetermined period and the payment amount of the current purchase exceeds the maximum amount of payment.

In one embodiment of the present invention, the limiting means may determine whether or not to limit the current purchase processing based on the price of the one or more items that the user purchases and a reference amount based on respective prices of a plurality of items associated with the one or more items, the plurality of items and the one or more items being associated by information for associating the one or more items with the plurality of items that relate to the one or more items, in a case where the total of the payment amount of the user in the predetermined period and the payment amount of the current purchase exceeds the maximum amount of payment.

In one embodiment of the present invention, the limiting means may determine whether or not to limit the current purchase processing based on an attribute of one or more items included in the user's past purchase in the predetermined period, in a case where the total of the payment amount of the user in the predetermined period and the payment amount of the current purchase exceeds the maximum amount of payment.

In one embodiment of the present invention, the limiting means determines whether or not to limit the current purchase processing based on a ratio of a total payment amount of the one or more items, which are included in the user's past purchase in the predetermined period and have an attribute associated with the purchase limit target, to the maximum amount of payment, the attribute of the one or more items and the purchase limit target being associated with by information for associating an item with the purchase limit target, in a case where the total of the payment amount of the user in the predetermined period and the payment amount of the current purchase exceeds the maximum amount of payment.

In one embodiment of the present invention, the limiting means determines whether or not to limit the current purchase processing based on a ratio of a total payment amount of the one or more items, which are included in the user's past purchase in the predetermined period and have an attribute not associated with the purchase limit target, to the maximum amount of payment, the attribute of the one or more items and the purchase limit target being associated with by information for associating an item with the purchase limit target, in a case where the total of the payment amount of the user in the predetermined period and the payment amount of the current purchase exceeds the maximum amount of payment.

In one embodiment of the present invention, in a case where the total of the payment amount of the user in the predetermined period and the payment amount of the current purchase exceeds the maximum amount of payment, the limiting means may determine whether or not to limit the current purchase processing based on an amount by which the total exceeds the maximum amount of payment.

In one embodiment of the present invention, the limiting means may determines not to limit the current purchase processing, in a case where the total of the payment amount of the user in the predetermined period and the payment amount of the current purchase exceeds the maximum amount of payment and a ratio of the amount by which the total exceeds the maximum amount of payment to a minimum value of the prices of the one or more items included in the current purchase is less than a predetermined ratio.

In one embodiment of the present invention, the limiting means may determine not to limit the current purchase processing, in a case where the total of the payment amount of the user in the predetermined period and the payment amount of the current purchase exceeds the maximum amount of payment, and the amount by which the total exceeds the maximum amount of payment is less than a charge included in the purchase.

In one embodiment of the present invention, the limiting means may determine whether or not to limit the current purchase processing based on a time when the user purchase the one or more items in the predetermined period, in a case where the total of the payment amount of the user in the predetermined period and the payment amount of the current purchase exceeds the maximum amount of payment.

In one embodiment of the present invention, the payment amount may be an amount obtained by multiplying a price of each of the one or more items that the user purchases by a quantity of the items, adding the charge included in the purchase to the amount, and subtracting a payment deduction amount determined according to the user from the amount.

In one embodiment of the present invention, the limiting means may determine to limit the current purchase processing in a case where the total of the payment amount of the user in the predetermined period exceeds the maximum amount of payment.

### BRIEF DESCRIPTION OF DRAWINGS

FIG. 1 A diagram illustrating an example of a configuration of an e-commerce system according to an embodiment of the present invention.

FIG. 2 A diagram illustrating an example of a configuration of a virtual mall server according to the embodiment of the present invention.

FIG. 3 A functional block diagram illustrating functions implemented by the virtual mall server according to the embodiment of the present invention.

FIG. 4 A diagram illustrating an example of a flow of processing performed by a maximum payment inputting unit.

FIG. 5 A diagram illustrating an example of a maximum payment setting screen.

FIG. 6 A diagram illustrating an example of user information stored in a user information storing unit.

FIG. 7 A diagram illustrating an example of a flow of processing performed by a purchase processing unit and a purchase limiting unit.

FIG. 8 A diagram illustrating an example of a flow of processing performed by the purchase processing unit and the purchase limiting unit.

FIG. 9 A diagram illustrating an example of a product selecting screen.

FIG. 10 A diagram illustrating an example of product information stored in a product information storing unit.

FIG. 11 A diagram illustrating an example of a warning screen of a maximum amount of payment.

FIG. 12 A diagram illustrating an example of a cart display screen for displaying content of a cart.

FIG. 13 A diagram illustrating an example of a payment/delivery method setting screen.

FIG. 14 A diagram illustrating an example of a message screen for displaying that purchase is not possible.

FIG. 15 A diagram illustrating an example of information on an order stored in an order history storing unit.

FIG. 16 A diagram illustrating an example of a flow of processing performed by a cart confirming unit or an order decision confirming unit included in the purchase limiting unit.

FIG. 17 A diagram illustrating an example of information on purchase limit.

### DESCRIPTION OF EMBODIMENTS

An embodiment of the present invention will be described below in detail with reference to the accompanying drawings. Regarding the elements designated with the same numerals, the explanation of the elements appearing later will be omitted unless they have different descriptions.

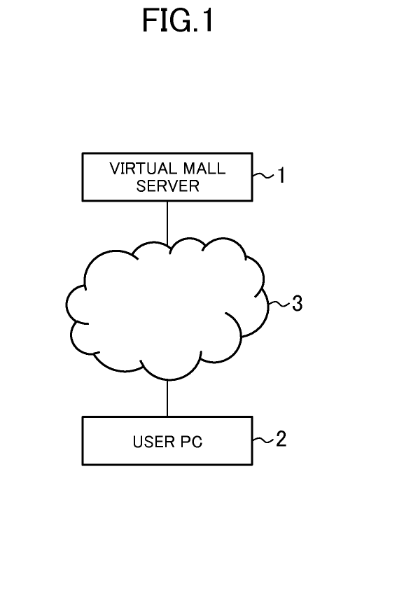

FIG. 1 is a diagram illustrating an example of configuration of an e-commerce system according to an embodiment of the present invention. The e-commerce system includes a virtual mall server 1 and a user PC2 of a user who uses an e-commerce service provided by the virtual mall server 1. The virtual mall server 1 and the user PC2 are connected to each other through the Internet 3, which is a type of networks.

The virtual mall server 1 implements functions of a shop that performs e-commerce transactions. Specifically, the virtual mall server 1 implements functions of purchase management, customer management, and product management. The purchase management function includes, in particular, functions of product search, product introduction, receiving orders, and payment. The user PC2 is, for example, a personal computer. Other server or client computer may implement only the function of purchase management of the virtual mall server 1. In the following, a case is explained where the virtual mall server 1 handles goods, although the virtual mall server 1 may, of course, handle services in a similar way. Here, goods and services together are referred to as “items.”

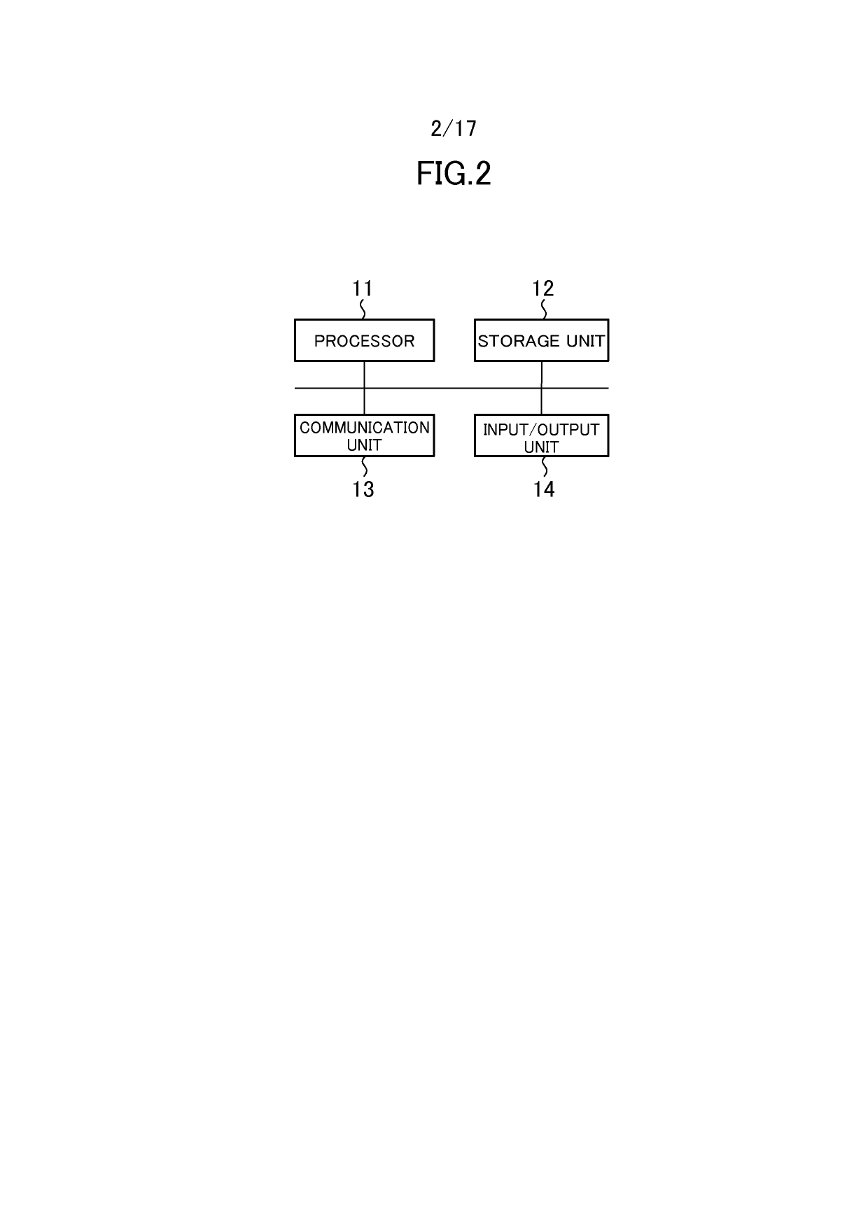

FIG. 2 is a diagram illustrating an example of hardware configuration of the virtual mall server 1 according to the embodiment of the present invention. The virtual mall server 1 includes a processor 11, a storage unit 12, a communication unit 13, and an input/output unit 14. The virtual mall server 1 may be a server computer installed in a data center, for example.

The processor 11 operates according to a program stored in the storage unit 12. The processor 11 controls the communication unit 13 and the input/output unit 14. The program may be provided through a network such as the Internet, or stored in a computer-readable storage medium such as a DVD-ROM to be provided.

The storage unit 12 includes a memory device such as a RAM or a flash memory, and a hard disk drive. The storage unit 12 stores the program. The storage unit 12 stores information and computational results input from each unit.

The communication unit 13 implements functions to communicate with other devices such as the user PC2, and includes, for example, an integrated circuit constituting a wire LAN and a network card having a communication terminal. The communication unit 13 inputs information received from other devices into the CPU 11 or the storage unit 12, and sends information to other devices based on the control of the CPU 11.

The input/output unit 14 is a circuit for exchanging data with a display output device or an input device, and includes, for example, a graphic board for outputting images on the display output device, and a USB controller obtaining data from an input device such as a keyboard and a mouse. The input/output unit 14 outputs image data to the display output device and obtains information from an operator (user) using the input device, based on the control of the processor 11.

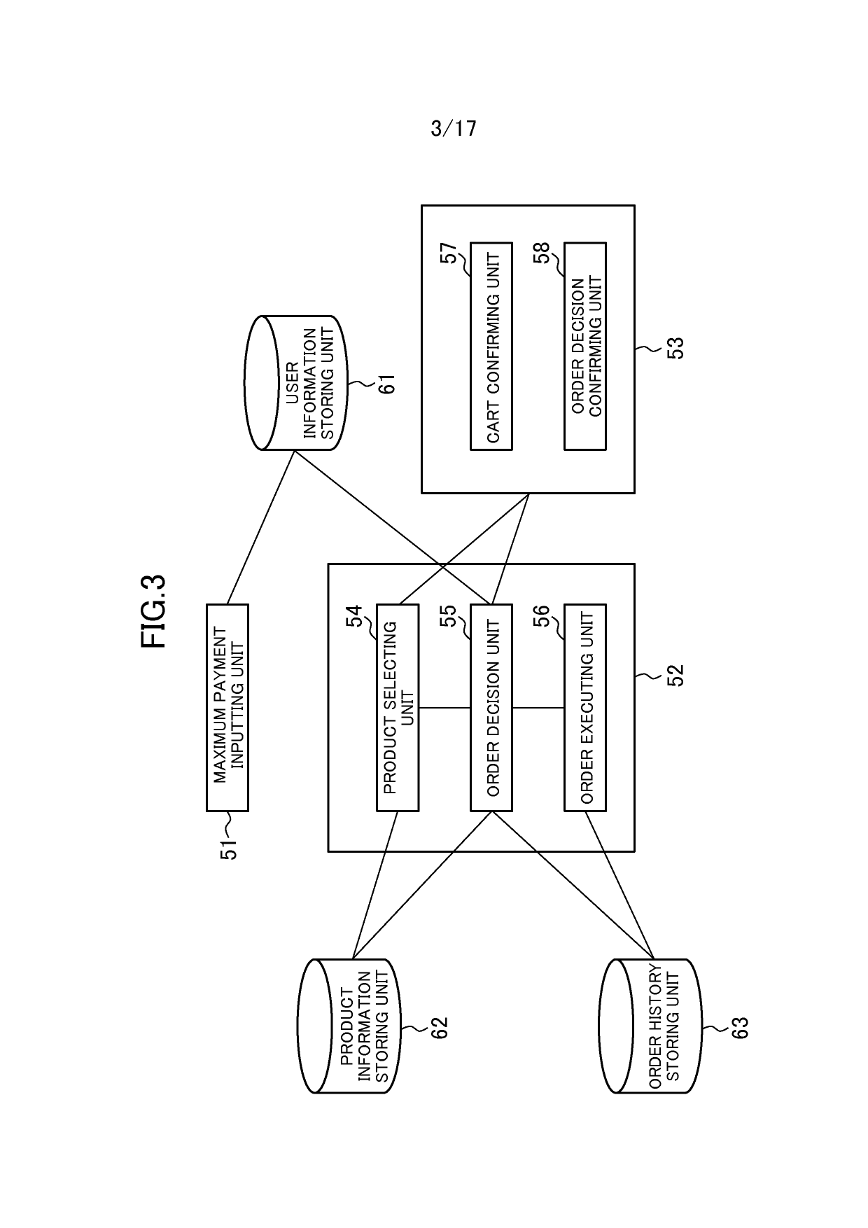

FIG. 3 is a functional block diagram illustrating functions implemented by the virtual mall server 1 according to the embodiment of the present invention. The virtual mall server 1 functionally includes the maximum payment inputting unit 51, the purchase processing unit 52, and the purchase limiting unit 53. The purchase processing unit 52 functionally includes the product selecting unit 54, the order decision unit 55, and the order executing unit 56, and the purchase limiting unit 53 includes the cart confirming unit 57 and the order decision confirming unit 58. These functions are implemented by the processor 11, which is included in the virtual mall server 1, executing a program stored in the storage unit 12 and controlling the communication unit 13. The user information storing unit 61, the product information storing unit 62, and the order history storing unit 63 are implemented by the storage unit 12 of the virtual mall server 1. The user information storing unit 61, the product information storing unit 62, and the order history storing unit 63 may be implemented by, for example, storage means of other server. Further, the maximum payment inputting unit 51, the purchase processing unit 52, and the purchase limiting unit 53 may be implemented by, for example, a processor and a storage unit that are included in a client, such as a mobile terminal, which has payment functions, instead of the virtual mall server 1. The processing specific to a case of mobile terminals will be explained as needed.

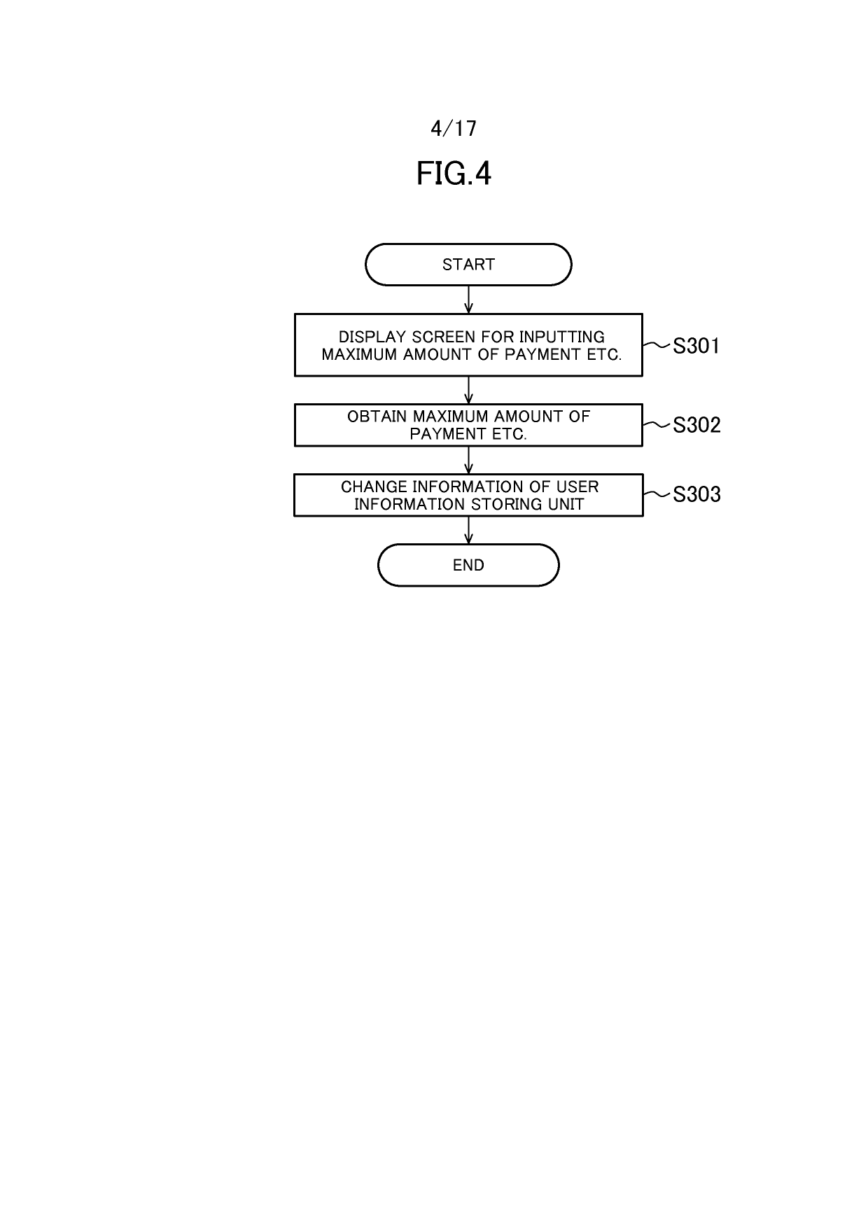

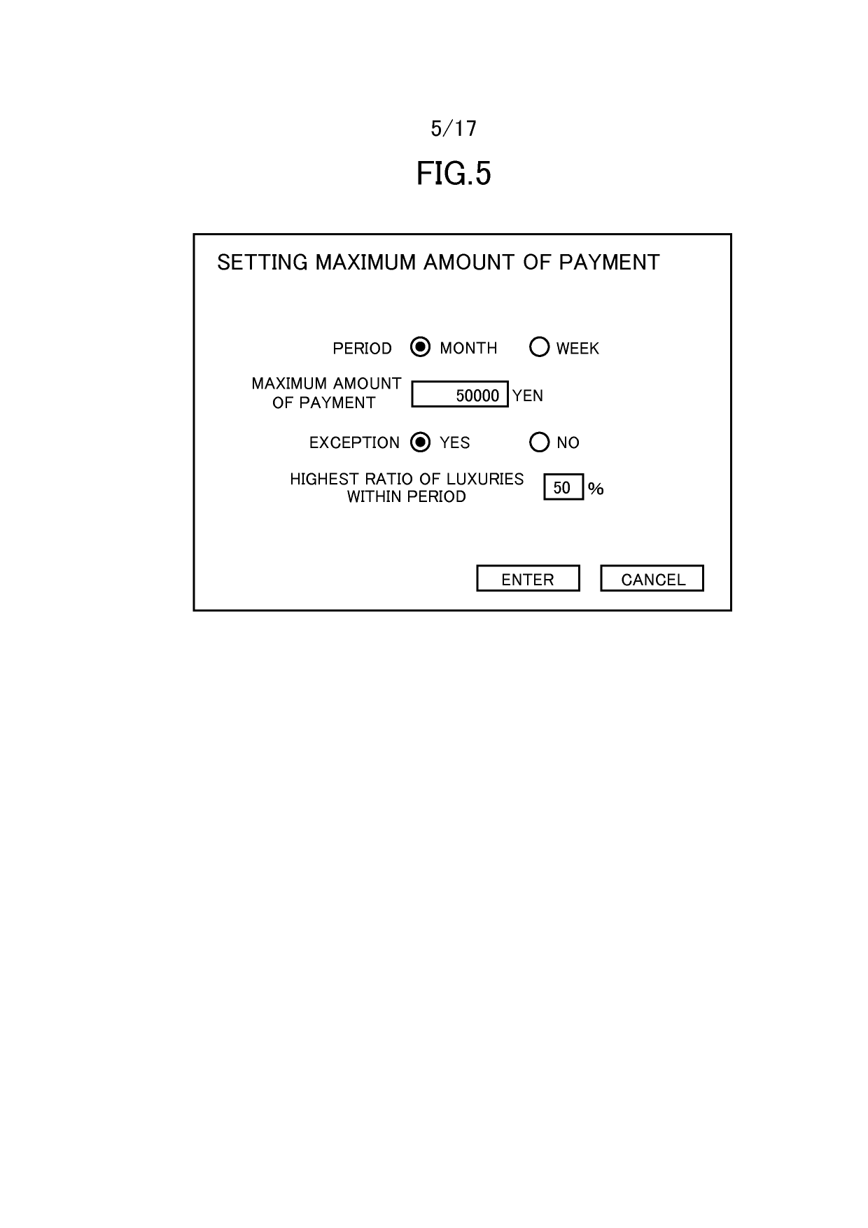

FIG. 4 is a diagram illustrating an example of a processing flow of the maximum payment input unit 51. The maximum payment inputting unit 51 is implemented mainly by the processor 11, the storage unit 12 and the communication unit 13. In the following, the maximum payment inputting unit 51 is described using the diagram of the processing flow. The maximum payment inputting unit 51 obtains, through the communication unit 13, information on e.g., the maximum amount of payment in a predetermined period which is input in the user PC2 by the user, and stores the obtained information in the storage unit 12. Specifically, the maximum payment inputting unit 51 generates image data (e.g., HTML data) for displaying a maximum payment setting screen to input an accumulation period (corresponding to the predetermined period), a maximum amount of payment, whether there is an exception in determining the maximum amount of payment, and upper limit (“highest ratio of luxuries within the period” in FIG. 5) of ratio of payment amount of purchase limit target product within a period, and sends the generated image data to the user PC2 through the communication unit 13 (Step S301). The user PC2 displays the maximum payment setting screen on a display connected to the user PC2 based on the image data. The accumulation period (e.g., monthly or weekly basis) is a period for calculating the total of the payment amount to be compared with the maximum amount of payment.

FIG. 5 is a diagram illustrating an example of the maximum payment setting screen. The maximum payment setting screen is a screen displayed on a browser. The user inputs the maximum amount of payment and the highest ratio of payment amount of purchase limit target products within the period in the input field, and uses radio buttons to input the accumulation period and the exception check. The maximum payment setting screen shown in FIG. 5 has an “ENTER” button and a “CANCEL” button. When the user inputs the maximum amount of payment or the like in the input field on the maximum payment setting screen and presses the “ENTER” button, the user PC2 sends such information to the virtual mall server 1. The cancellation of the maximum amount of payment may be executed, for example, when the user empties the field of the maximum amount of payment.

Next, the maximum payment inputting unit 51 obtains, from the user PC2, the accumulation period, the maximum amount of payment, the result of the exception check, and the upper limit ratio of payment amount of purchase limit target products within the period (Step S302). Subsequently, the maximum payment inputting unit 51 changes user information of the operating use, which is stored in the user information storing unit 61, based on such information (Step S303).

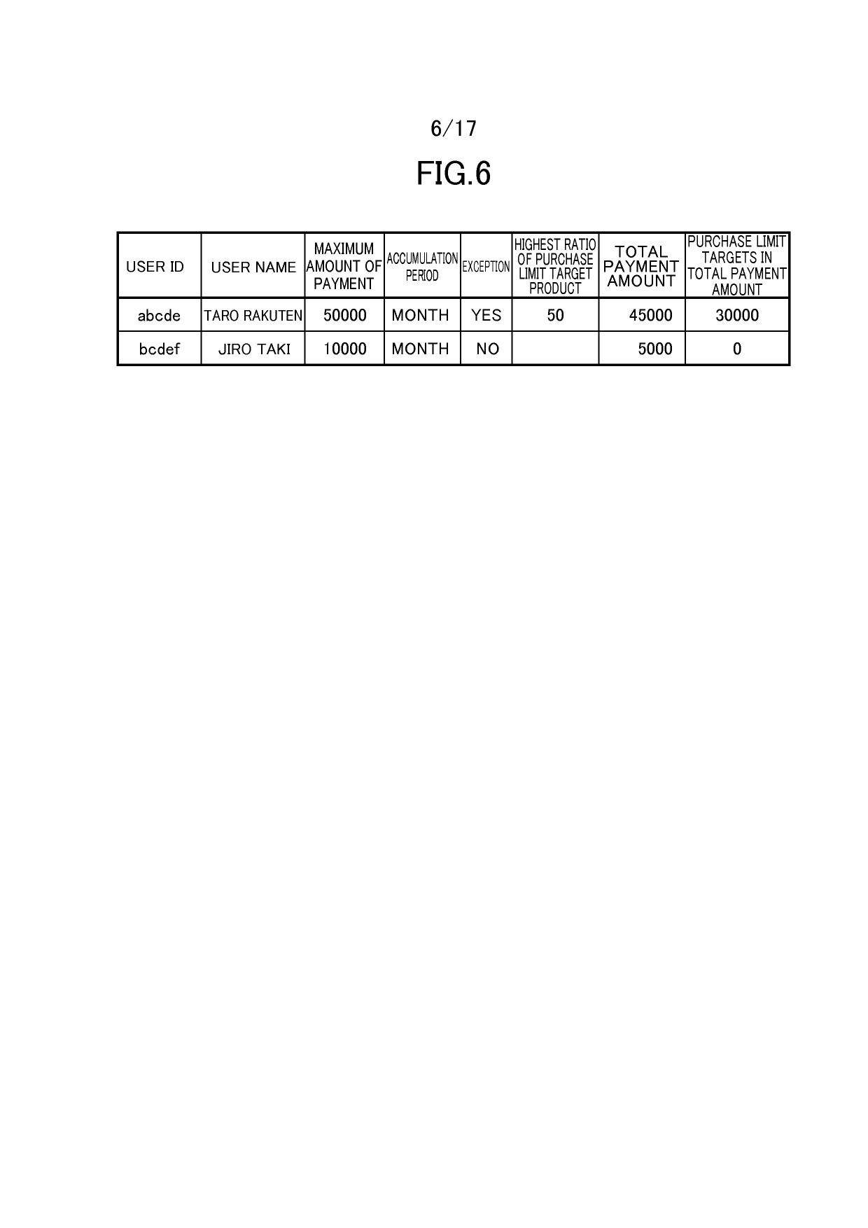

FIG. 6 is a diagram illustrating an example of user information stored in the user information storing unit 61. The user information storing unit 61 stores apiece of user information for each user. A piece of user information includes information on a user ID, a user name, a maximum amount of payment, an accumulation period, an exception, the highest ratio of purchase limit target product, a total of payment amounts in the period, and a total of payment amounts of purchase limit target products in the period. The maximum payment inputting unit 51 overwrites the respective fields of the user information, including the maximum amount of payment, the accumulation period, the exception, and the highest ratio of the purchase limit target products, with the maximum amount of payment, the accumulation period, the result of the exception check, the highest ratio of payment amount of purchase limit target products, which are entered via the maximum payment setting screen. In the example of FIG. 6, the field of the maximum amount of payment also shows information on whether or not the maximum amount of payment is set. For example, if the maximum amount of payment is not set, or the maximum amount of payment that is previously set is cancelled, the field of the maximum amount of payment may be empty.

The purchase processing unit 52 is mainly implemented by the processor 11, the storage unit 12, and the communication unit 13. The purchase processing unit 52 determines the current order including the goods that the user purchases based on the input from the user, and executes purchase processing according to the determined order. The purchase limiting unit 53 is mainly implemented by the processor 11 and the storage unit 12. When the total of the user's payment amounts in the accumulation period and the payment amounts of the current order exceeds the maximum amount of payment, the purchase limiting unit 53 limits the current purchase processing of the purchase processing unit 52 based on the user's past or current order.

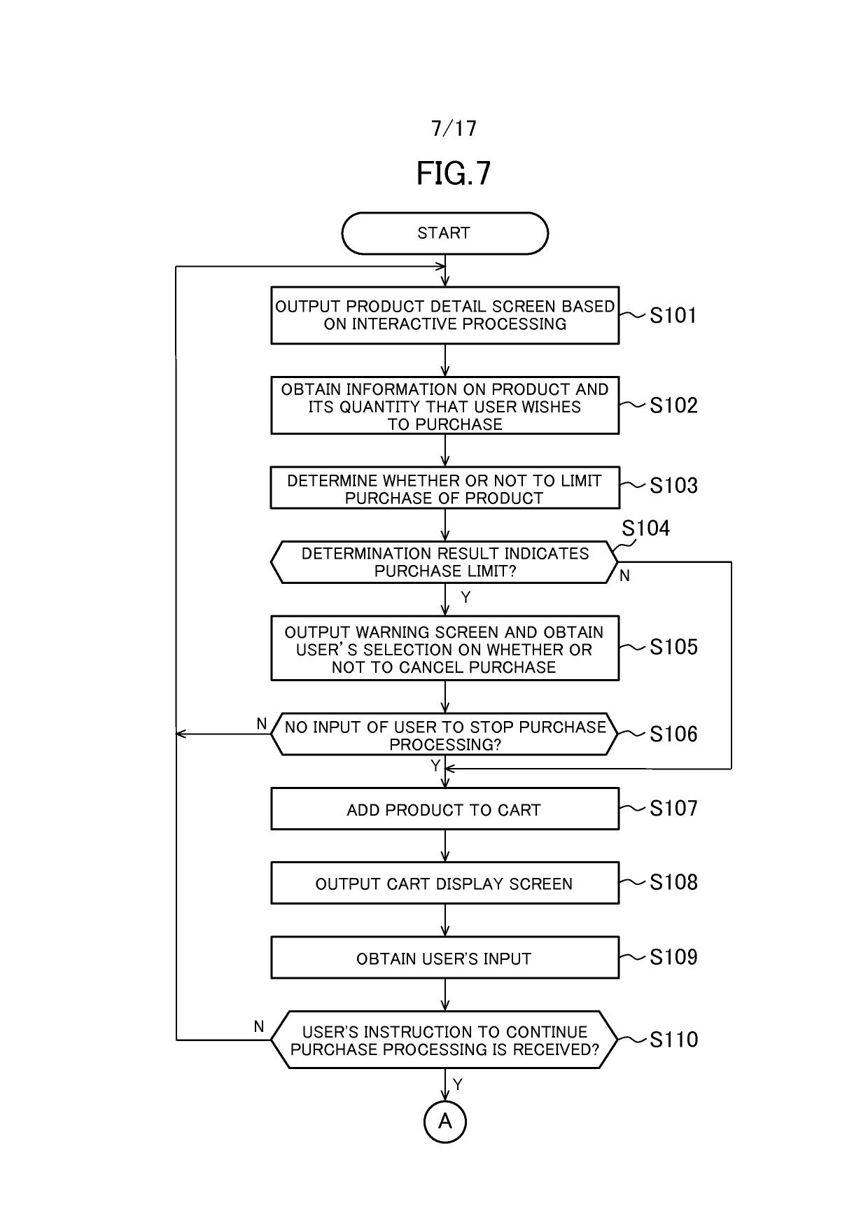

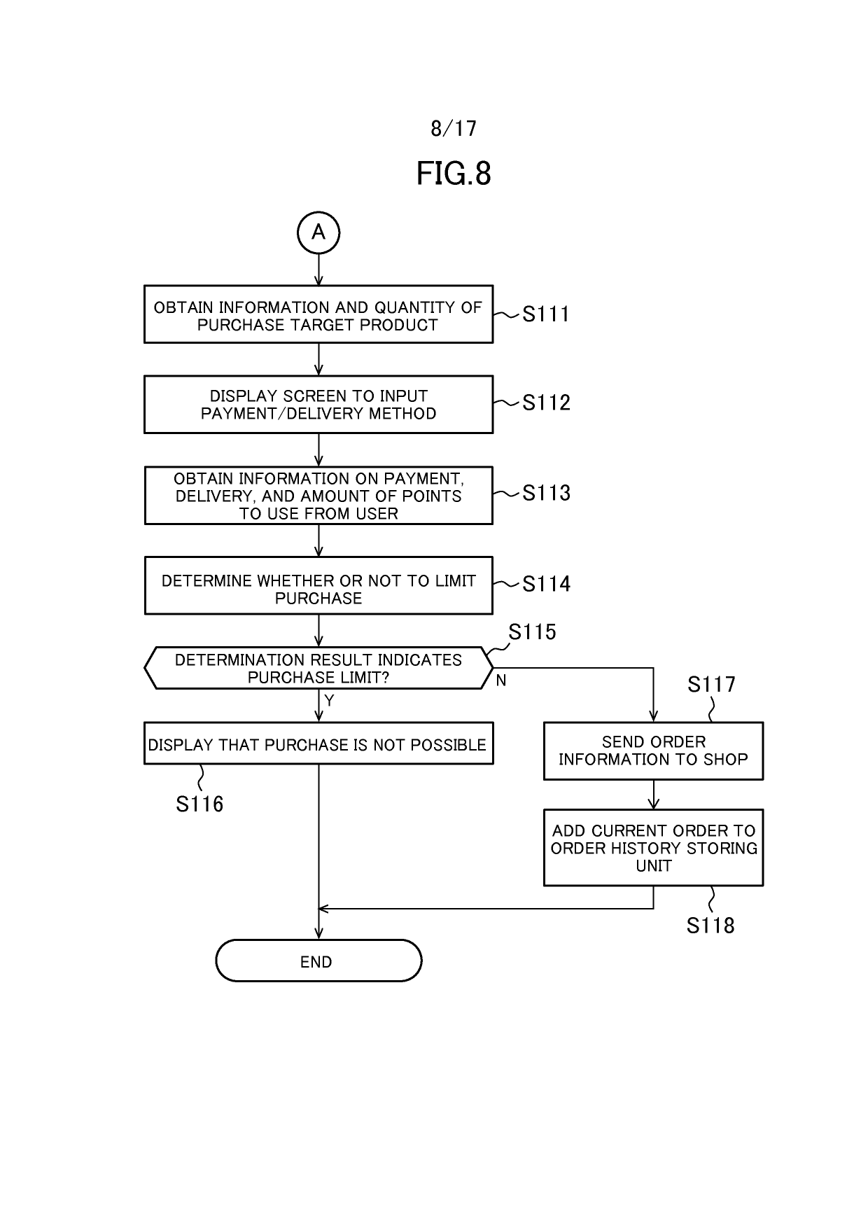

FIGS. 7 and 8 illustrate examples of processing flows of the purchase processing unit 52 and the purchase limiting unit 53. In the following, the processing executed by these units is explained according to the processing flows.

The product selecting unit 54 included in the purchase processing unit 52 is mainly implemented by the processor 11, the storage unit 12, and the communication unit 13. The product selecting unit 54 obtains information of a product that the user wishes to purchase, adds the obtained product to a shopping cart (cart), and sends an order based on the content in the shopping cart to the order decision unit 55.

Specifically, the product selecting unit 54 outputs image data of a product detail screen based on interactive processing (Step S101). The user PC2 outputs the product detail screen based on the image data. The product detail screen is a screen for displaying explanation and prices of products. The product selecting unit 54 displays a product search screen and a product list screen on the user PC2, and specifies products to be output on the product detail screen based on the search condition input by the user or the products selected by the user on the screen. The product detail screen of the specified products is output to the user PC2.

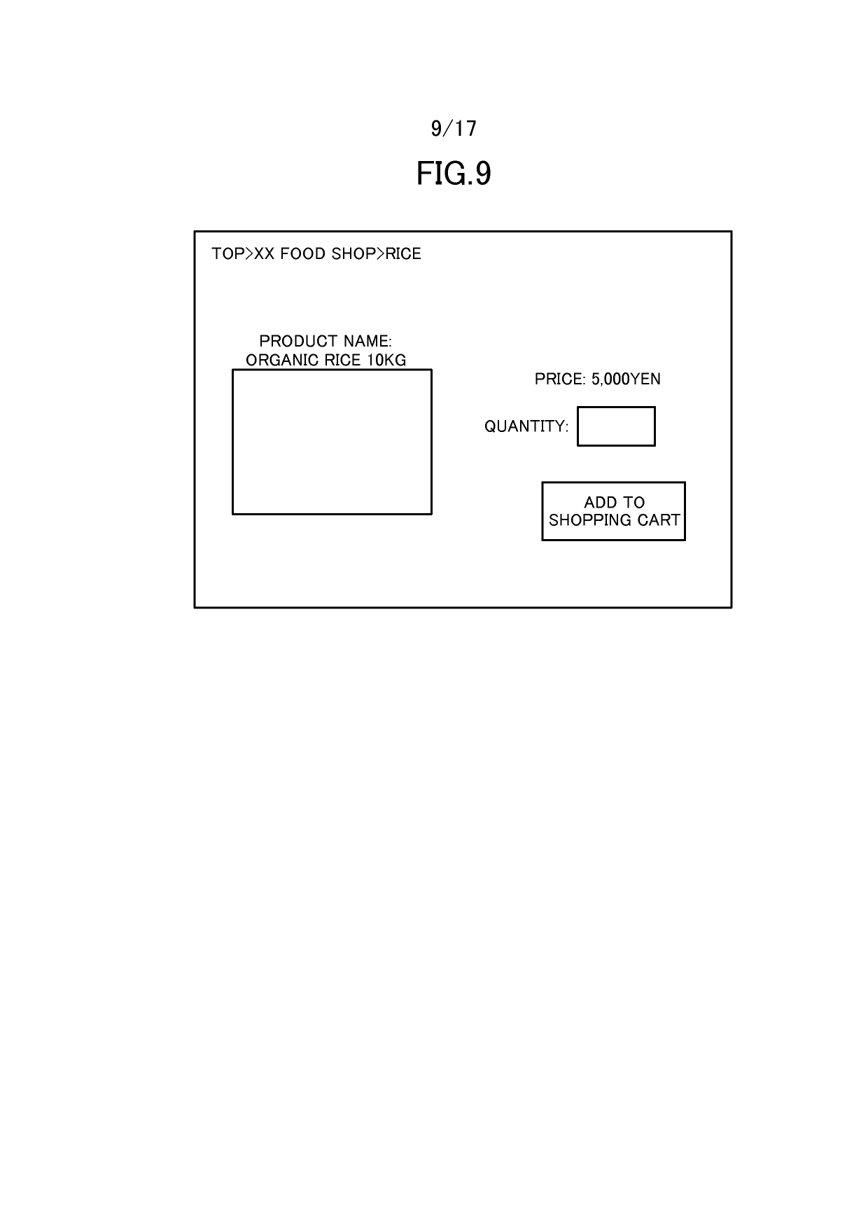

FIG. 9 is a diagram illustrating an example of the product detail screen. The product detail screen includes a shop name, product name, image of the product (square frame under the product name in FIG. 9), a unit price, and like. The product detail screen also includes a quantity field to input the number of products and a button for adding the product to the shopping cart. When the user inputs the number of the products to purchase in the quantity field and press the “Add to shopping cart” button, information on the product and the quantity is sent to the product selecting unit 54.

Subsequently, the product selecting unit 54 obtains information on the product and the quantity that the user inputs, in other words, information on the product and its quantity that the user wishes to purchase (Step S102). The information of the product obtained by the product selecting unit 54 includes the product's product ID, quantity, shop ID of a shop selling the product, and unit price.

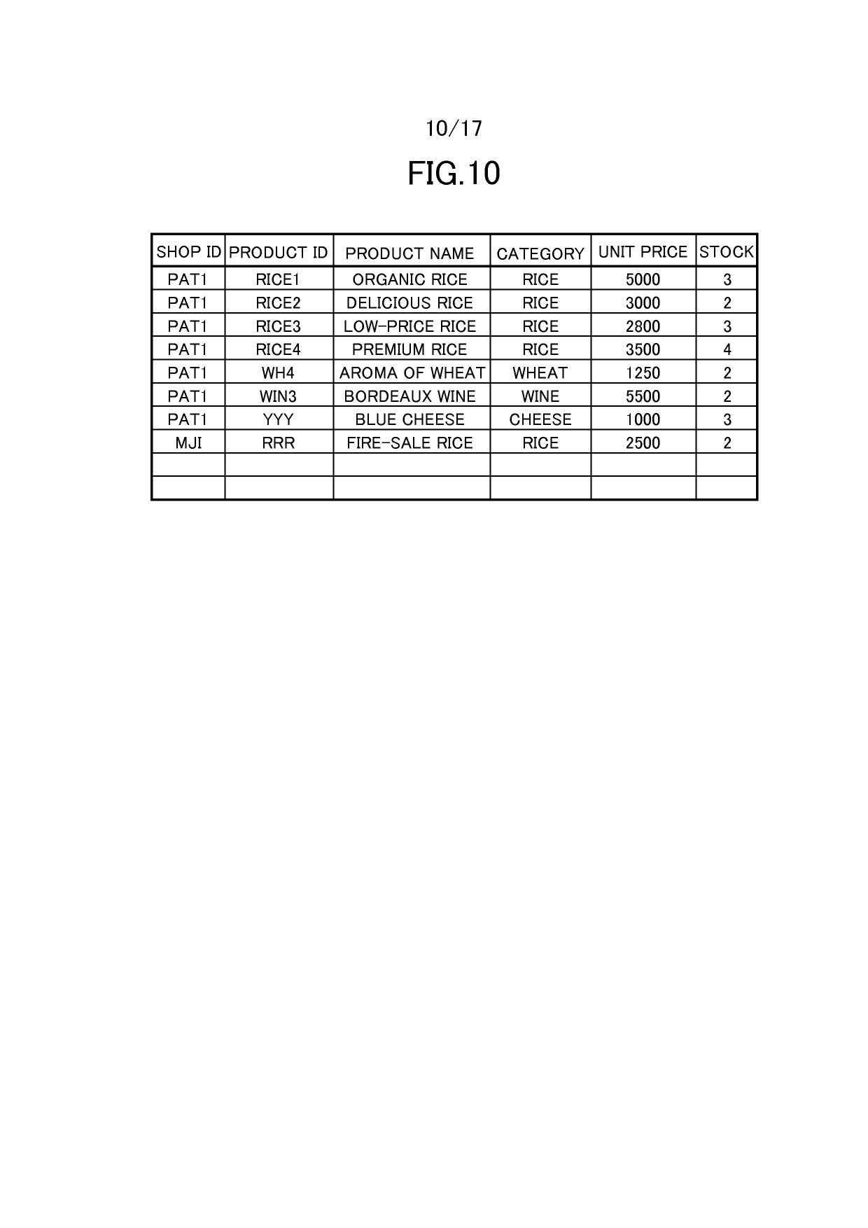

The information on the product is product information that the product selecting unit 54 originally obtains from the product information storing unit 62. The product information is information sent from the product selecting unit 54 to the user PC2 when the product detail screen is output. FIG. 10 is a diagram illustrating an example of product information stored in the product information storing unit 62. The product information storing unit 62 stores information output to the product selecting screen and information obtained by the product selecting unit 54, except for quantity. The product information storing unit 62 stores a piece of product information for each combination of a shop and a product. For example, the product information includes information on shop ID, product ID, product name, product category, unit price, and quantity of stock.

When the user obtains information and quantity of the product to purchase (order detail at the present time), the product selecting unit 54 inquires a cart confirming unit 57 included in the purchase limiting unit 53 about whether or not to limit the purchase of the product using the information, and the cart confirming unit 57 determines whether or not to limit the purchase of the product (Step S103). The cart confirming unit 57 and the order decision confirming unit 58, which are included in the purchase limiting unit 53, determine whether or not to limit the purchase of the product based on the maximum amount of payment and the total of the past payment amounts and the current payment amount (including predicted amount). The current payment amounts used in Step S103 is exactly a predicted amount of the payment amount, and obtained by multiplying a price of each product that the user wishes to purchase by a quantity of products. The details of determining purchase limit performed by the cart confirming unit 57 and the order decision confirming unit 58 are explained later. The predicted amount may be an amount obtained by subtracting a deductible amount from the amount obtained by multiplying a price of each product that the user wishes to purchase by a quantity of products. In this case, the deductible amount is, for example, remaining point amount and unused gift money amount. The point amount is added, for example, when the user purchases a product. The gift money amount is electronically sent from other users and added. The remaining point amount and the gift money amount are associated with the user and stored in the storage unit 12.

When the determination result, which is the answer from the cart confirming unit 57, indicates no purchase limit (“N” in Step S104), the product selecting unit 54 proceeds to the processing to add the product to the cart in Step S107. When the determination result indicates purchase limit (“Y” in Step S104), the product selecting unit 54 outputs a warning screen toward the user, and obtains a result of selection whether or not to cancel the purchase from the user through the user PC2 (Step S105).

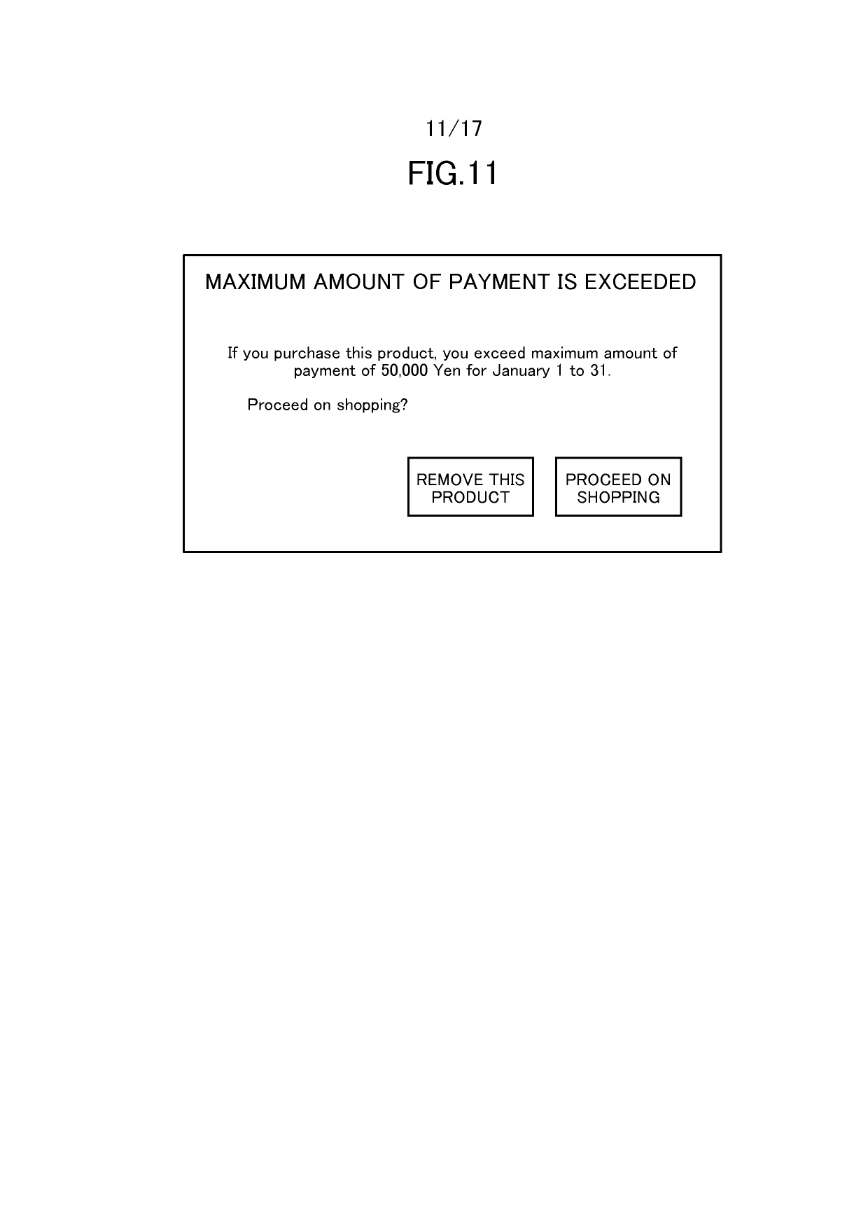

FIG. 11 is a diagram illustrating an example of the warning screen about the maximum amount of payment. When the amount exceeds the maximum amount of payment, and other conditions used in the cart confirming unit 57 are satisfied, the product selecting unit 54 outputs the warning screen. The user selects either of adding the product to the shopping cart (“Proceed on Shopping” button) or stopping the purchase processing of the product (“Remove this product” button) on the warning screen.

When there is no input of the user to stop the purchase processing (in a case where “Proceed on Shopping” button is pressed in the example of FIG. 11) (“N” in Step S106), information on the product and the quantity is added to the cart (Step S107). When there is an input of the user to stop the purchase processing in a case where “Remove this product” button is pressed in the example of FIG. 1 (“N” in Step S106), information on the product is not added to the cart, and the processing returns to Step S101. In this way, the purchase processing of the purchase processing unit 52 is controlled. In this regard, a product can be added to the cart with the payment limit in order to allow the user to wait for the current accumulation period to pass while the product is placed in the cart.

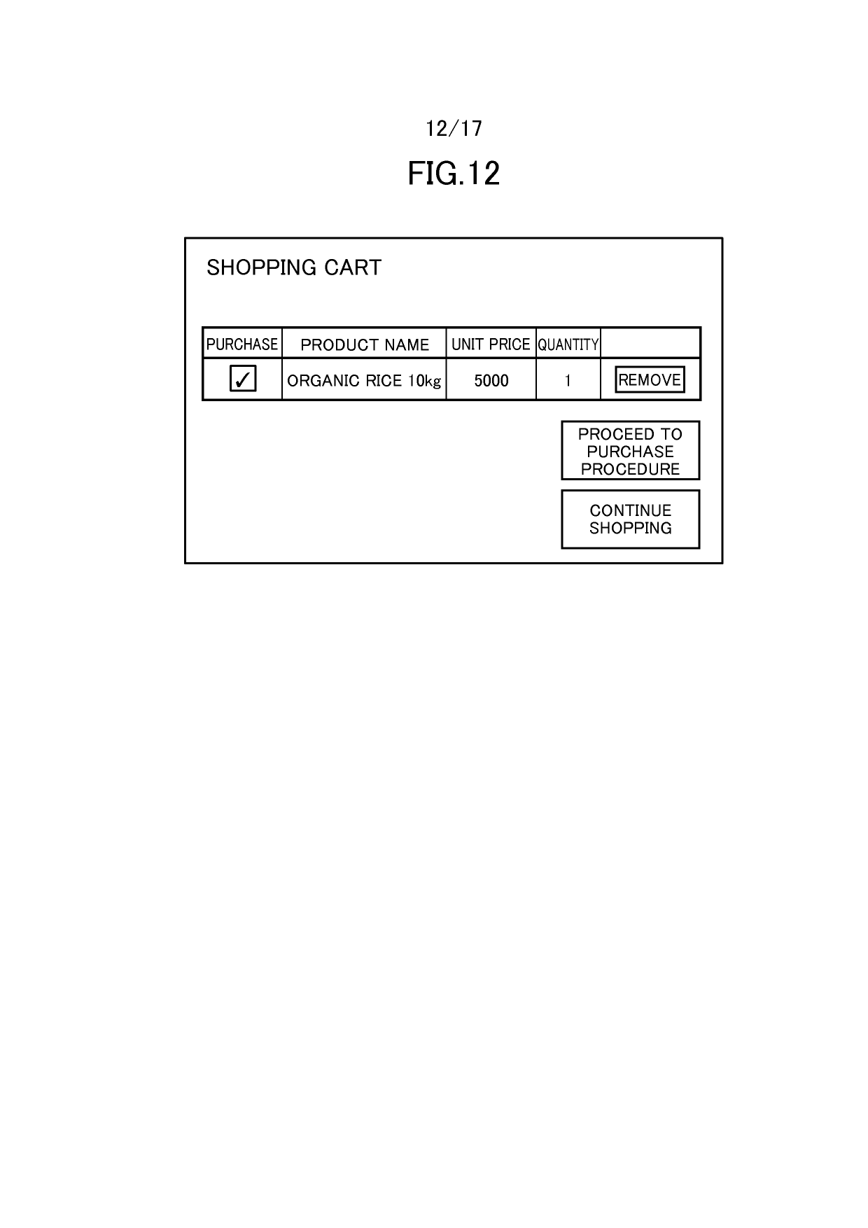

When the information and the quantity of the product are added to the cart, the product selecting unit 54 outputs image data of a cart display screen indicative of the content of the cart to the user PC2 (Step S108). FIG. 12 is a diagram illustrating an example of the cart display screen indicative of the content of the cart. On the cart display screen, the user can remove the product by pressing the “Remove” button, specify the product to currently purchase by checking the “Purchase” checkbox, and selecting whether to proceed the purchase by pressing “Proceed to Purchase Procedure” and “Continue Shopping” buttons. The description of the details of the processing of “Remove” button are omitted.

Subsequently, the product selecting unit 54 obtains the user's input regarding the cart screen (Step S109). Upon receiving the user's instruction to proceed the purchase processing (“Y” in Step S110), the product selecting unit 54 proceeds to the processing of the order decision unit 55 on Step S111 and after. On the other hand, upon receiving the user's instruction to continue to select products (“N” in Step S110), the processing returns to Step S101.

The order decision unit 55 included in the purchase processing unit 52 is mainly implemented by the processor 11 and the storage unit 12. The order decision unit 55 determines the order based on information on the product to be purchased obtained from the product selecting unit 54 and settings of payment and delivery methods input by the user.

First, the order decision unit 55 obtains information on the product specified on the cart screen as the target of purchase and the quantity of the product (Step S111). Next, the order decision unit 55 outputs, to the user PC2, data for displaying the screen on which payment and delivery methods are input (Step S112).

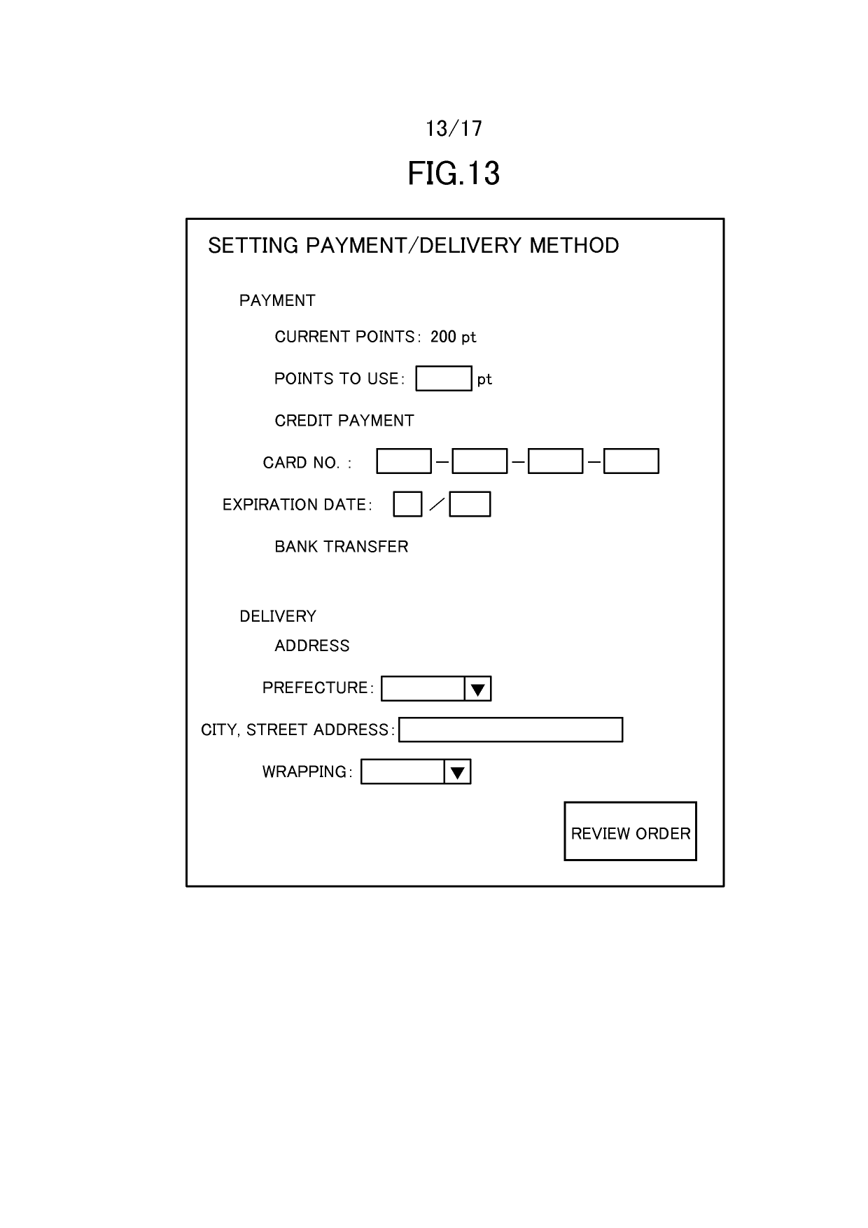

FIG. 13 is a diagram illustrating an example of a payment/delivery method setting screen. The payment/delivery method setting screen includes a field to enter points to use, fields to specify the payment method, and fields to specify the delivery method (delivery address and necessity of wrapping). The user sends such information to the order decision unit 55 with use of the payment/delivery method setting screen.

Subsequently, the order decision unit 55 obtains information on the payment method, delivery method, and amount of points to use from the user (Step S113). Such information is used for determining a charge included in the order and the current payment amount. For example, the delivery method determines a delivery charge, and the payment method determines a payment charge (e.g., cash on delivery charge). Further, an amount deducted from the payment amount of the user (here, referred to as payment deduction amount) is determined by a discount amount such as amount of point usage or amount of gift coupon to use (not shown). The payment amount of the current order is an amount totalizing the amounts obtained by multiplying a price of each product by a quantity of products and the charges such as the payment charge and delivery charge, and deducting the payment deduction amount.

Subsequently, the order decision unit 55 inquires the order decision confirming unit 58 included in the purchase limiting unit 53 about whether or not to limit purchase with use of information on, for example, payment/delivery method and amount of points to use. Further, the order decision confirming unit 58 determines whether or not to limit purchase (Step S114). The details of the processing of the order decision confirming unit 58 are explained later.

When the determination result, which is the answer from the order decision confirming unit 58, indicates purchase limit (“Y” in Step S115), the order decision unit 55 outputs, to the user PC2, information on the screen displaying that purchase is not possible (Step S116), and finishes the processing. When the determination result indicates no purchase limit (“N” in Step S115), the order executing unit 56 executes the processing in Step S117 and after.

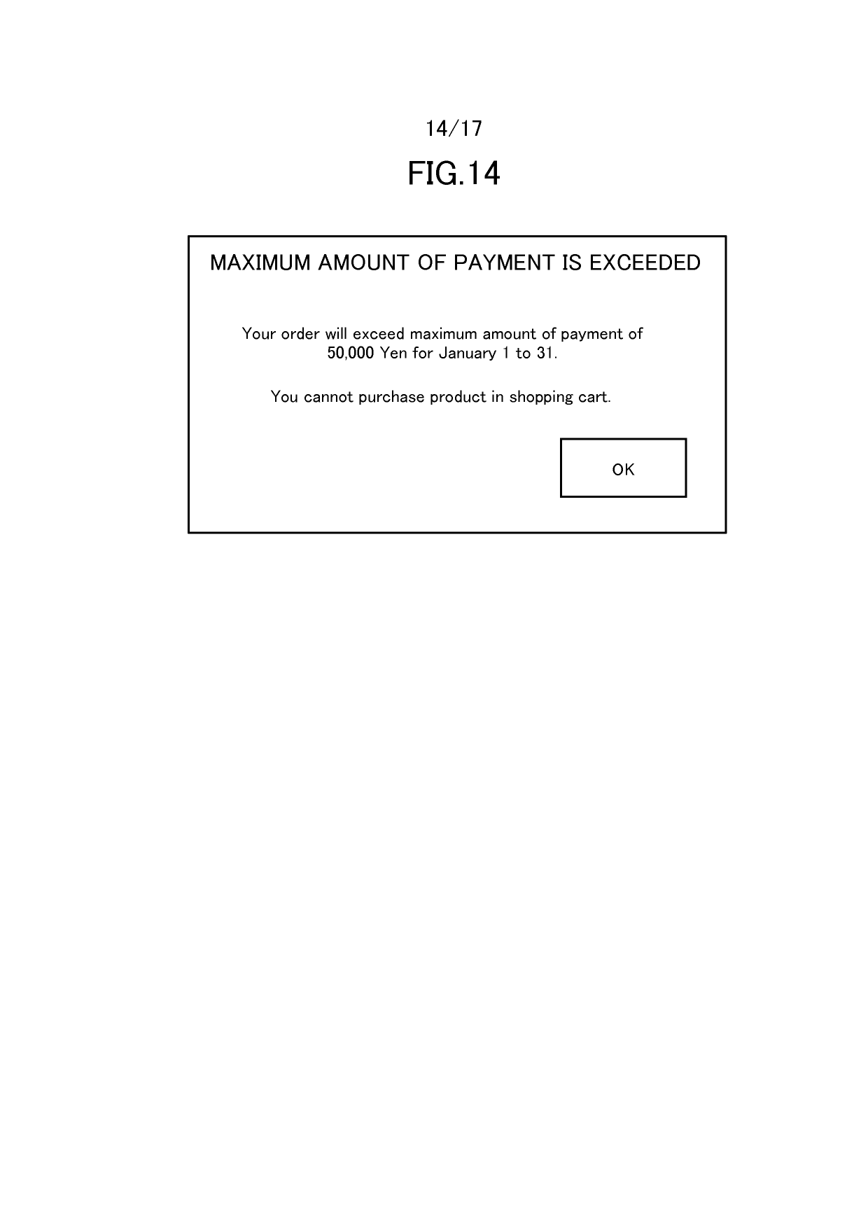

FIG. 14 is a diagram illustrating an example of a screen displaying a message that purchase is not possible when the purchase is limited. When the “OK” button is pressed, the processing relating to the purchase is finished.

The order executing unit 56 included in the purchase processing unit 52 is mainly implemented by the processor 11, the storage unit 12, and the communication unit 13. The order executing unit 56 executes purchase processing in accordance with the order determined by the order decision unit 55. Specifically, the order executing unit 56 sends information on the order to a shop selling the products included in the order (Step S117). The order executing unit 56 may send data to a computer that manages payment using the payment method specified by the user and shipping based on the previous setting of the shop. Subsequently, the order executing unit 56 adds the current order to the order history storing unit 63 (Step S118) and the payment amount of the current order to the total payment amount in the user information, and writes the total amount in the field. The order executing unit 56 calculates the amount of the purchase limit target products among the payment amounts, adds the calculated amount to the amount of the purchase limit target products of the user information, and writes the amount in the field. Then, the current purchase processing is finished. In this way, user the purchase processing is controlled according to content of an order. The purchase limit target product is described later.

The purchase processing unit 52 implemented by a mobile terminal may execute the purchase processing by obtaining the details of purchase (which may include amount, date and time of purchase, and product) indicated by the user from, for example, a POS terminal at a shop, inquiring the purchase limiting unit 53 about whether or not to limit the purchase based on the details of purchase, and executing the payment processing when obtaining an answer that the purchase is possible from the purchase limiting unit 53. Here, the details of purchase include not only the details of order, but also the details when the purchase is made at a shop.

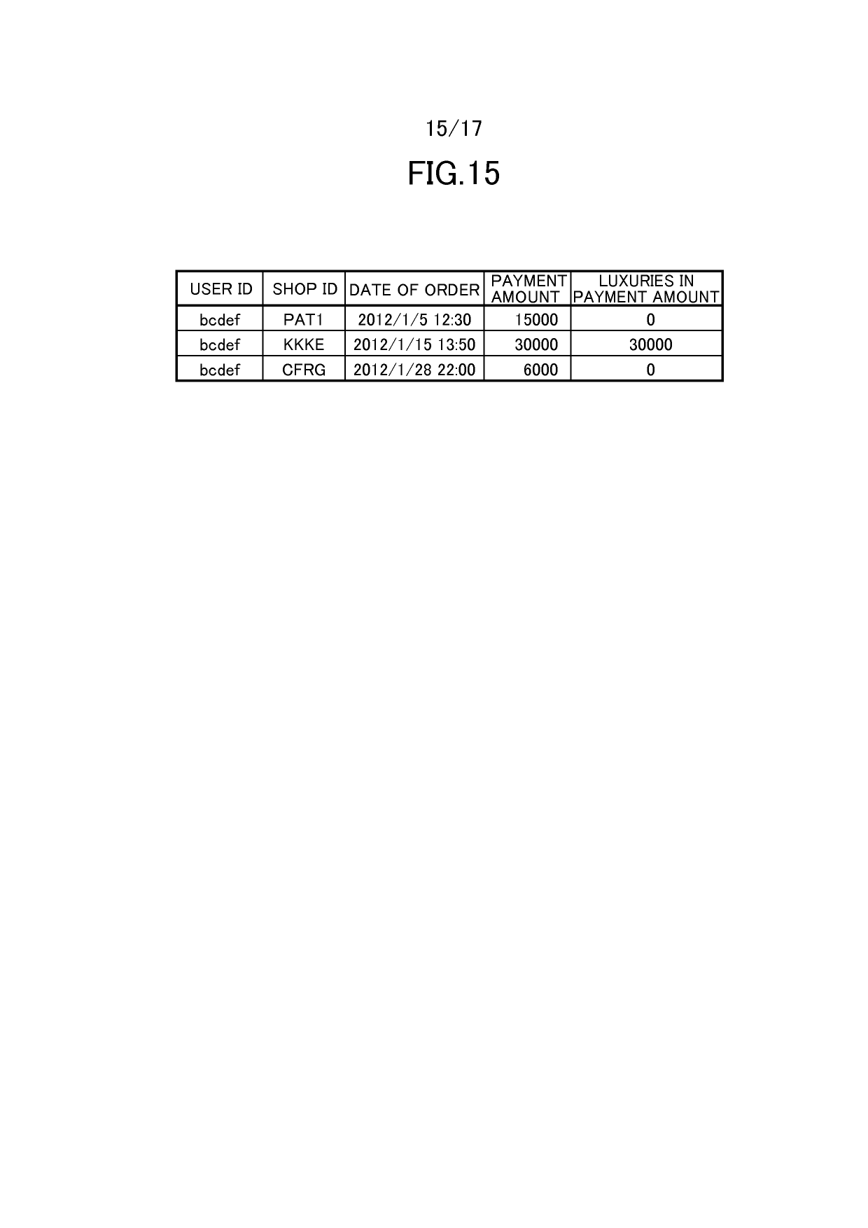

FIG. 15 is a diagram illustrating an example of information on details of orders stored in the order history storing unit 63. The details of orders in the order history shown in FIG. 15 includes user IDs, shop IDs, date and time of orders, payment amounts, amounts paid for purchase limit target products, but may also include information on product IDs and quantity of products.

In the following, processing of the purchase limiting unit 53 is described in detail. The purchase limiting unit 53 is mainly implemented by the processor 11 and the storage unit 12. When a total of the user's payment amount and a payment amount of the current order exceeds the maximum amount of payment in the accumulation period, the purchase limiting unit 53 limits the current purchase processing of the purchase processing unit 52 based on the user's current or past orders.

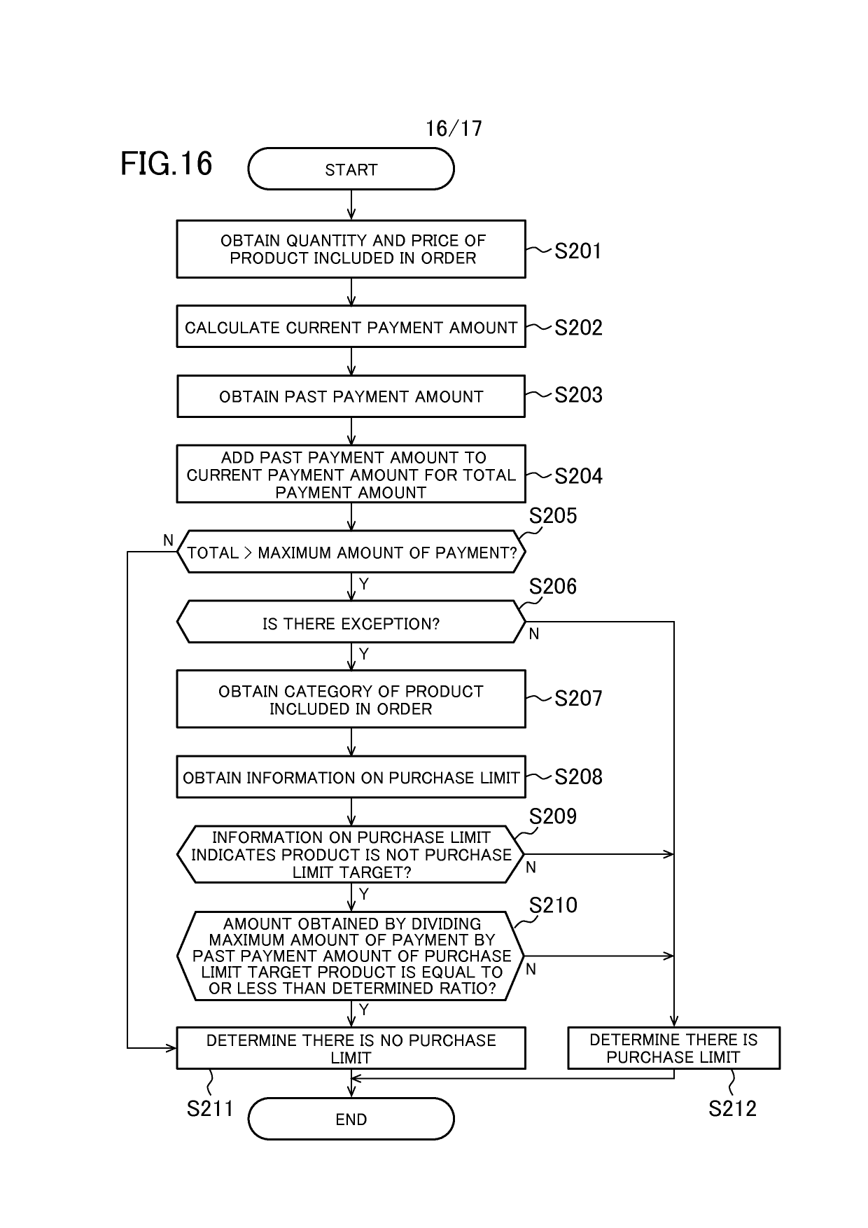

FIG. 16 is a diagram illustrating an example of a processing flow of the cart confirming unit 57 or the order decision confirming unit 58 included in the purchase limiting unit 53. The cart confirming unit 57 and the order decision confirming unit 58 respectively determine whether or not to limit purchase by using the processing flow shown in FIG. 16 so as to control the purchase processing unit 52 to proceed the purchase processing. The main difference between the processing of the cart confirming unit 57 and the processing of the order decision confirming unit 58 is calculation method of the current payment amount. In the following, the processing described as the processing of the purchase limiting unit 53 is, unless otherwise specifically stated, the processing executed by the cart confirming unit 57 and the order decision confirming unit 58 respectively. The following explains the processing in a case where the maximum amount of payment is set. If the maximum amount of payment is cancelled, the purchase limiting unit 53 always determines that purchase is not limited.

The purchase limiting unit 53 obtains a quantity and a price of a product included in the order (Step S201). Subsequently, the purchase limiting unit 53 obtains information on points or the like, and calculates the current payment amount (Step S202). Specifically, the cart confirming unit 57 obtains information on the remaining point amount and the gift money amount, and the order decision confirming unit 58 obtains information on the amount of points to use, the amount of gift coupon to use, and the charges. The cart confirming unit 57 and the order decision confirming unit 58 respectively calculate the current payment amount based on the obtained information.

The current payment amount will be discussed below. As described above, the current payment amount calculated by the cart confirming unit 57 is a predicted amount of the payment amount, and obtained by multiplying a price of each of products by a quantity of the products that the user wishes to purchase. Specifically, the cart confirming unit 57 calculates an amount by multiplying a price of each of products included in the order (cart) by a quantity of the products as the payment amount. The cart confirming unit 57 may calculate the payment amount by subtracting the amount of points to use or the amount of gift coupon to use from the amount obtained by multiplying a price of each of products included in the order (cart) by a quantity of the products. The current payment amount calculated by the order decision confirming unit 58 is determined by the user's input of the payment method, the delivery method, and the amount of points to use, and is amount obtained by multiplying a price of each of products by a quantity of the products, adding the payment charges and delivery charges, and subtracting the payment deduction amount such as the amount of points to use and the amount of gift coupon to use.

Subsequently, the purchase limiting unit 53 obtains a total of the past payment amounts in the accumulation period (Step S203). The total of the past payment amounts may be obtained from the user's user information, or by obtaining information on the orders processed in the accumulation period from the order history storing unit 63 and calculating a total of the payment amounts of the orders. The purchase limiting unit 53 then adds the past payment amount to the current payment amount, and obtains the total of the payment amount in the accumulation period and the current payment amount (Step S204). If the obtained total is equal to or less than the maximum amount of payment (“N” in Step S205), the purchase limiting unit 53 determines that there is no purchase limit, and returns the result to the querying unit (Step S211). On the other hand, if the total exceeds the maximum amount of payment (“Y” in Step S205), the purchase limiting unit 53 checks if the user information includes an exception of purchase limit (Step S206). If no exception is set (“N” in Step S206), the purchase limiting unit 53 determines there is purchase limit, and if an exception is set (“Y” in Step S206), the purchase limiting unit 53 checks if it is a case in which the limit is acceptable for the purpose of preventing waste of money.

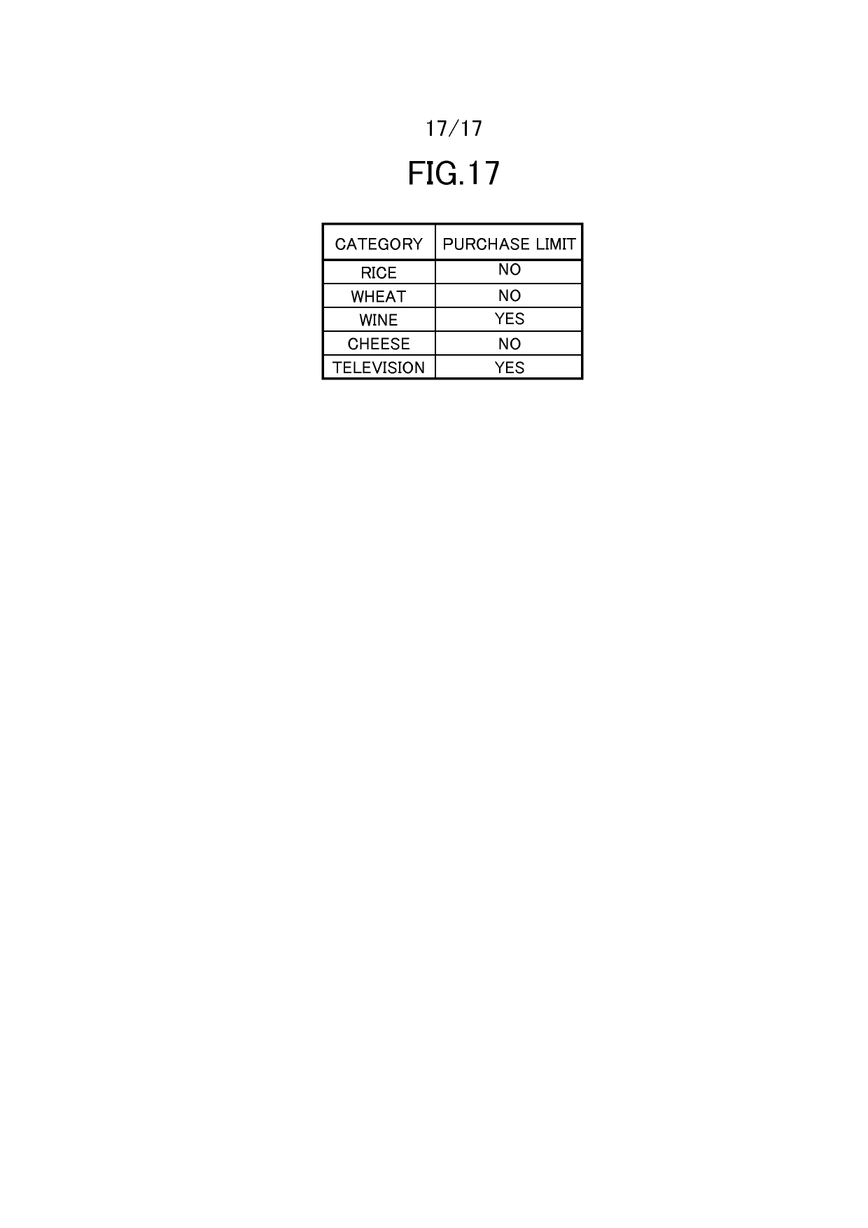

In Step S207, the purchase limiting unit 53 obtains a category of the product included in the order. Subsequently, the purchase limiting unit 53 obtains information on purchase limit about the category (Step S208). FIG. 17 is a diagram illustrating an example of the information on purchase limit. The information on purchase limit is information that associates a category of a product with whether or not the product has purchase limit. The information on purchase limit may associate other attributes of the product, such as a product name, instead of a category. In this case, such attribute may be used in the processing in Step S207 and Step S208 instead of a category. If the information on purchase limit associates the attribute of the product included in the order with purchase limit, it is indicated that the product is a target of the purchase limit. If no, it is indicated that the product is not a target of the purchase limit. The purchase limit target products are generally associated with luxuries.

If the information on purchase limit indicates that the product is a target of the purchase limit (“N” in Step S209), the purchase limiting unit 53 determines that there is purchase limit, and returns the determination result to the querying unit (Step S212). If the information on purchase limit indicates that the product is not a target of the purchase limit (“Y” in Step S209), the purchase limiting unit 53 checks the payment amount of the past purchase limit target products.

Specifically, the payment amount of the past purchase limit target products is a total of the payment amounts for the purchase limit target products among the orders stored in the order history storing unit 63 and processed in the accumulation period. When an amount obtained by dividing the maximum amount of payment by the past payment amounts of purchase limit target products is equal to or less than the highest ratio of the purchase limit target product stored in the user information (“Y” in Step S210), the purchase limiting unit 53 determines that there is no purchase limit, and returns the determination result to the inquiring unit (Step S211). When the obtained amount exceeds the highest ratio of the purchase limit target products stored in the user information, the purchase limiting unit 53 determines that there is purchase limit and returns the determination result to the inquiring unit (Step S212). This determination may be made by using a total of the payment amounts of the products that are not the target of purchase limit. In this case, the user information may include information on the lowest ratio of non-purchase limit target products. If the amount is equal to or more than the lowest ratio, the purchase limit may not be set, and the amount is less than the lowest ratio, the purchase limit may be set.

In this way, even though the amount exceeds the maximum amount of payment, it is possible to permit the user to purchase products that are not purchase limit target products and are unlikely waste of money. Further, by checking the ratio of the amount spent for the purchase limit target products in the past orders, it is possible to change whether or not to permit the user to purchase the product depending on the extent of the user's past expenditure.

The purchase limiting unit 53 may use other than the information on purchase limit in order to determine whether or not to limit the purchase. For example, a unit price of a product included in the order may be compared with an average unit price of similar products in order to determine whether or not to limit the purchase. The similar products are products associated with the products included in the order using the attributes of the products, and may be other products having the same product name as the products, for example. Specifically, instead of performing the processing from Steps S207 to S210, the purchase limiting unit 53 may calculate an average unit price of products having the same product name, and set the product having higher unit price than the average unit price under the purchase limit, and the product having lower unit price than the average unit price without the purchase limit.

The purchase limiting unit 53 may determine whether or not to limit the purchase based on an amount (excess amount) that exceeds the maximum amount of payment among the total of the payment amount in the accumulation period and the current payment amount. For example, instead of performing the processing from Steps S207 to S210, the purchase limiting unit 53 may determine whether or not the excess amount is less than the charges included in the order, and if the excess amount is less than the charges, permit the user to purchase without limit. By eliminating the charges, which are difficult to estimate in advance, it is possible to prevent the user from being confused.

Alternatively, the purchase limiting unit 53 may determine whether to limit the purchase by preliminary setting of the highest ratio of an excess amount in a price of a product. Instead of performing the processing from Steps S207 to S210, in a case where the order includes multiple products, the purchase limiting unit 53 may select the lowest unit price of the products and determine not to set limits for the purchase if the ratio of the excess amount to the lowest unit price does not exceed the upper limit. For example, in a case where the highest ratio of the excess amount is 50% and the remainder to the maximum amount of payment is 10,000 Yen, the user is not allowed to purchase a product of 10,000 Yen and a product of 1,000 Yen, and the user is allowed to purchase a product of 5,000 Yen and a product of 6,000 Yen. The former case prevents the user from spending the amount almost close to the maximum amount of payment by giving up the product of 1,000 Yen, and the latter case permits the user to purchase the products in a case where more amount is left over to the maximum amount of payment if the user gives up one of the products. In this way, the management of the maximum amount of payment can be provided in a flexible manner depending on the situation of the user.

The purchase limiting unit 53 may determine whether or not to limit the purchase depending on the time when the user purchases the product in the accumulation period. For example, instead of performing the processing from Steps S207 to S210, the purchase limiting unit 53 may permit the user to purchase the product without limit if the time when the user purchases the product is within the predetermined period (e.g., within three days) from the end of the accumulation period, since the user has saved money until then. Otherwise, the purchase limiting unit 53 may set limits for the purchase, since it does not appear that the user is willing to save money. This way also can flexibly permit the user to purchase products according to the situation of the user.

In Step S206, although there is an exception of purchase limit, the purchase limiting unit 53 may determine to set limits for the purchase if the past payment amount exceeds the maximum amount of payment. In a case where the past payment amount exceeds the maximum amount of payment, it is likely that the user recognizes it and amends the maximum amount of payment before ordering the product if the user really needs the product.

### REFERENCE SIGNS LIST

1 virtual mall server, 2 user PC, 3 Internet, 11 processor, 12 storage unit, 13 communication unit, 14 input/output unit, 51 maximum payment inputting unit, 52 purchase processing unit, 53 purchase limiting unit, 54 product selecting unit, 55 order decision unit, 56 order executing unit, 57 cart confirming unit, 58 order decision confirming unit, 61 user information storing unit, 62 product information storing unit, 63 order history storing unit.

The invention claimed is:

1. A purchase managing device, comprising:
maximum payment inputting means for causing a storage unit to store a maximum amount of payment in a predetermined period, the maximum amount of payment being input by a user;
purchase means for executing purchase processing according to a current purchase including one or more items that the user purchases, each of the one or more items being at least one of goods and service; and
limiting means for determining whether a total of a payment amount of the user in the predetermined period and a payment amount of the current purchase exceeds the maximum amount of payment or not and for determining, in a case where it is determined that the total exceeds the maximum amount of payment, whether or not to permit the current purchase processing by the purchase means according to an attribute of the one or more items that the user currently purchases.

2. (canceled)

3. The purchase managing device according to claim 1,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on information for associating an attribute of an item with whether or not the item is a purchase limit target and the attribute of the one or more items that the user wishes to purchase.

4. The purchase managing device according to claim 1,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on a price of the one or more items that the user purchases, the price being obtained from means for storing respective prices of a plurality of items.

5. The purchase managing device according to claim 4,
wherein, in a case where it is determined that the total of the payment amount of the user in the predetermined period and the payment amount of the current purchase exceeds the maximum amount of payment, the limiting means determines whether or not permit the current purchase processing in which the total exceeds the maximum amount of payment based on the price of the one or more items that the user purchases and a reference amount based on respective prices of a plurality of items associated with the one or more items, the plurality of items and the one or more items being associated by information for associating the one or more items with the plurality of items that relate to the one or more items.

6. The purchase managing device according to claim 1,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on an attribute of one or more items included in the user's past purchase in the predetermined period.

7. The purchase managing device according to claim 6,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on a ratio of a total payment amount of the one or more items, which are included in the user's past purchase in the predetermined period and have an attribute associated with the purchase limit target, to the maximum amount of payment, the attribute of the one or more items and the purchase limit target being associated by information for associating an item with the purchase limit target.

8. The purchase managing device according to claim 6,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on a ratio of a total payment amount of the one or more items, which are included in the user's past purchase in the predetermined period and have an attribute not associated with the purchase limit target, to the maximum amount of payment, the attribute of the one or more items and the purchase limit target being associated with by information for associating an item with the purchase limit target.

9. The purchase managing device according to claim 1,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on an amount by which the total exceeds the maximum amount of payment.

10. The purchase managing device according to claim 9,
wherein, in a case where it is determined that the total of the payment amount of the user in the predetermined period and the payment amount of the current purchase exceeds the maximum amount of payment, and a ratio of the amount by which the total exceeds the maximum amount of payment to a minimum value of the prices of the one or more items included in the current purchase is less than a predetermined ratio, the limiting means determines to permit the current purchase processing in which the total exceeds the maximum amount of payment.

11. The purchase managing device according to claim 9,
wherein, in a case where it is determined that the total of the payment amount of the user in the predetermined period and the payment amount of the current purchase exceeds the maximum amount of payment, and the amount by which the total exceeds the maximum amount of payment is less than a charge included in the purchase, the limiting means determines to permit the current purchase processing in which the total exceeds the maximum amount of payment.

12. The purchase managing device according to claim 1,
wherein, in a case where it is determined that the total of the payment amount of the user in the predetermined period and the payment amount of the current purchase exceeds the maximum amount of payment, the limiting means determines whether or not to permit the current purchase processing in which the total exceeds the maximum amount of payment based on whether a time when the user purchases the one or more items is within a certain period from the end of the predetermined period.

13. The purchase managing device according to claim 1,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

14. (canceled)

15. A purchase managing method, comprising:
causing a storage unit to store a maximum amount of payment in a predetermined period, the maximum amount of payment being input by a user;
executing purchase processing according to a current purchase including one or more items that the user purchases, each of the one or more items being at least one of goods and service;
determining whether a total of a payment amount of the user in the predetermined period and a payment amount of the current purchase exceeds the maximum amount of payment or not; and
determining, in a case where it is determined that the total exceeds the maximum amount of payment, whether or not to permit the current purchase processing according to an attribute of the one or more items that the user currently purchases.

16. (canceled)

17. A non-transitory computer-readable information storage medium for storing a program that causes a computer to execute:
causing a storage unit to store a maximum amount of payment in a predetermined period, the maximum amount of payment being input by a user;
executing purchase processing according to a current purchase including one or more items that the user purchases, each of the one or more items being at least one of goods and service;
determining whether a total of a payment amount of the user in the predetermined period and a payment amount of the current purchase exceeds the maximum amount of payment or not; and
determining, in a case where it is determined that the total exceeds the maximum amount of payment, whether or not to permit the current purchase processing according to an attribute of the one or more items that the user currently purchases.

18. The purchase managing device according to claim 3,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

19. The purchase managing device according to claim 4,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

20. The purchase managing device according to claim 6,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

21. The purchase managing device according to claim 9,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

22. The purchase managing device according to claim 12,
wherein the payment amount is an amount obtained by multiplying a price of each of the one or more items that the user purchases by a quantity of the items, adding the charge included in the purchase to the amount, and subtracting a payment deduction amount determined according to the user from the amount, the payment deduction amount which decrease the payment amount.

23. The purchase managing device according to claim 1,
wherein, in a case where it is determined that the total exceeds the maximum amount of payment, the limiting means determine whether or not to permit the current purchase processing by the purchase means according to an attribute of the one or more items that the user currently purchases and a past purchase, in the predetermined period, of one or more items which have an attribute which has a different limit state from a limit state of the attribute of the one or more items that the user currently purchases.
